(19) United States
(12) Patent Application Publication
(10) Pub. No.: US 2026/0270157 A1
(43) Pub. Date: Sep. 10, 2026

(54) USING RADIO RESOURCE MANAGEMENT FUNCTIONS OF AN ACCESS POINT TO MODEL USER ACTIVITY AND ADJUST OPERATING PARAMETERS

(71) Applicant: Dell Products L.P., Round Rock, TX (US)

(72) Inventor: Prashanth Murthy, Plano, TX (US)

(21) Appl. No.: 19/072,907

(22) Filed: Mar. 6, 2025

(51) Int. Cl. H04L 41/16; H04L 41/5009; H04W 52/02

(52) U.S. Cl. CPC H04L 41/16; H04L 41/5009; H04W 52/0206

(57) ABSTRACT

The technologies described herein are generally directed to using radio resource management functions of an access point to model user activity and adjust operating parameters based thereon. For instance, a system can, by using an activity machine learning model, predict a demand level for a future time period, resulting in a demand prediction, with the activity machine learning model being trained based on a time series of wireless activity data representative of wireless communication activity that has previously occurred within the coverage area, and with the access point including at least a first communication manager and a second communication manager. The system may further, based on the demand prediction, adjusting an operation parameter of the second communication manager to manage wireless communications within the coverage area during the future time period.

### BACKGROUND

Modern approaches to managing wireless network resources may use machine learning capabilities. In some circumstances, machine learning data processing and training functions are centralized in dedicated management equipment, and the machine learning model generated may be applicable to broad collections of access point equipment.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method may include, by using an activity machine learning model applicable to demand for wireless communication in a coverage area served by an access point, predicting, by an access point, a demand level for a future time per., resulting in a demand prediction, with the activity machine learning model being trained based on a time series of wireless activity data representative of wireless communication activity that has previously occurred within the coverage area, and with the access point including at least a first communication manager and a second communication manager. The method may further include, based on the demand prediction, adjusting, by the access point, an operation parameter of the second communication manager to manage wireless communications within the coverage area during the future time period.

Additionally or alternatively, the method may further include collecting, by the access point, the time series of wireless activity data for use in training the activity machine learning model. Additionally or alternatively, the time series includes key performance indicators that include at least one of a first indicator of an average number of radio resource control connections, a second indicator of a number of session management packet data unit session setup requests, and third indicator of a utilization of radio remote unit physical resource block downlink/uplink resources. Additionally or alternatively, the first communication manager includes a distributed unit applicable to manage communication between a centralized unit of the access point and a radio unit of the access point.

Additionally or alternatively, the access point includes a next-generation node B access point. Additionally or alternatively, the demand prediction includes a predicted number of active users for the future time period. Additionally or alternatively, the altering of the operation parameter includes suspending operation of the second communication manager. Additionally or alternatively, the method may further include, before the suspending of the operation of the second communication manager, migrating active user sessions maintained by the second communication manager to the first communication manager. Additionally or alternatively, the adjusting of the operation parameter is further based on a combination of energy savings and demand fulfillment.

Additionally or alternatively, the machine learning activity model of demand includes a recurrent neural network. Additionally or alternatively, the recurrent neural network includes a long short-term memory neural network. Additionally or alternatively, the adjusting of the operation parameter of the second communication manager includes notifying a service management and orchestration function of an applicability of the demand prediction to the second communication manager.

An example system can operate as follows. At least one memory may store computer executable instructions, and at least one processor may be configured to process the computer executable instructions that, when executed by the at least one processor, facilitate performance of operations. The operations may include instantiating a first distributed unit function of a network at a first server and a second distributed unit function of the network at a second server, with a subset of resource blocks of a grid of resource blocks being served by the first distributed unit function and the second distributed unit function. The operations may further include, based on a sequence of activity values applicable to the subset of the resource blocks, modifying a weight of a recurrent connection represented in a machine learning data structure. The operations may further include, based on a power-conserving plan derived from inference data representative of an inference obtained from the machine learning data structure, migrating the first distributed unit function to the second server.

Additionally or alternatively, the inference is applicable to an expected volume of wireless traffic within the subset of the resource blocks. Additionally or alternatively, the power-conserving plan includes a plan to reduce power consumption by the network equipment by suspending use of the first server for distributed unit functions. Additionally or alternatively, the operations further include instantiating an operations, administration, and maintenance function applicable to the migrating of the first distributed unit function to the second server. Additionally or alternatively, the operations further include, based on the power-conserving plan, deactivating the second distributed unit function. Additionally or alternatively, the operations further include, based on training data received from a control plane of a centralized unit, further modifying the weight of the recurrent connection represented in the machine learning data structure.

An example non-transitory machine-readable medium may include executable instructions that, when executed by at least one processor, facilitate performance of operations. The operations may include receiving, from an artificial intelligence inference generator trained based on an aggregated traffic metric, an output that includes a traffic prediction applicable to the base station, with the aggregated traffic metric being obtained from a result of aggregation of multiple traffic metrics applicable to the base station. The operations may further include, based on the traffic prediction, changing an allocation of power resources to different parts of the base station. Additionally or alternatively, the multiple traffic metrics are limited to traffic metrics applicable to the base station.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate using radio resource management functions of an access point to model user activity and adjust operating parameters based thereon, in accordance with one or more embodiments;

FIG. 2 is an architecture diagram of an example system that can facilitate using radio resource management functions of an access point to model user activity and adjust operating parameters based thereon, in accordance with one or more embodiments;

FIG. 3 includes a diagram that illustrates aspects of example system that can facilitate using radio resource management functions of an access point to model user activity and adjust operating parameters based thereon, in accordance with one or more embodiments;

FIG. 4 includes a sequence diagram that illustrates aspects of example system that can facilitate using radio resource management functions of an access point to model user activity and adjust operating parameters based thereon, in accordance with one or more embodiments;

FIG. 5 includes a diagram that illustrates aspects of example system that can facilitate using radio resource management functions of an access point to model user activity and adjust operating parameters based thereon, in accordance with one or more embodiments;

FIG. 6 depicts a flow diagram representing example operations of an example method that can facilitate using radio resource management functions of an access point to model user activity and adjust operating parameters based thereon, in accordance with one or more embodiments;

FIG. 7 depicts an example system that can facilitate using radio resource management functions of an access point to model user activity and adjust operating parameters based thereon, in accordance with one or more embodiments;

FIG. 8 depicts an example non-transitory machine-readable medium that can include executable instructions that, when executed by a processor of a system, can facilitate using radio resource management functions of an access point to model user activity and adjust operating parameters based thereon, in accordance with one or more embodiments;

FIG. 9 is a schematic block diagram of a system with which the disclosed subject matter can interact; and

FIG. 10 illustrates an example block diagram of a computer operable to execute an embodiment of this disclosure.

### DETAILED DESCRIPTION

Various specific details of the disclosed embodiments are provided in the description below. One skilled in the relevant art(s) will recognize, however, that the techniques described herein can in some cases be practiced without one or more of the specific details, or with other methods, components, materials, etc. In other instances, well-known structures, materials, or operations are not shown or described in detail to avoid obscuring subject matter.

By utilizing one or more implementations as described herein, the performance, efficiency, and management of systems that manage signaling and power consumption overhead can be improved, e.g., by providing approaches that facilitate using machine learning capabilities that are deployed at managed systems. One or more embodiments described herein are not abstract concepts; rather, they provide technical solutions to technical problems associated with using activity model data to improve signaling and power consumption overhead for up to thousands of wireless network cell sites, without causing excessive service impacts. These technical solutions to technical problems are inextricably tied to computer systems and networks that manage the operation of broad and diverse wireless networks. Moreover, implementations described herein can provide these solutions in a manner that cannot reliably be performed by a human or even a plurality of humans, e.g., solutions provided generally must be provided continuously for networks of interconnected computer equipment.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

Generally speaking, some embodiments described herein relate to managing the operation of access point equipment based on a machine learning model that is locally trained with locally collected time series data describing different activity levels of a coverage area. As the machine learning model is utilized, results may be used to further train the model based on results of use of the model.

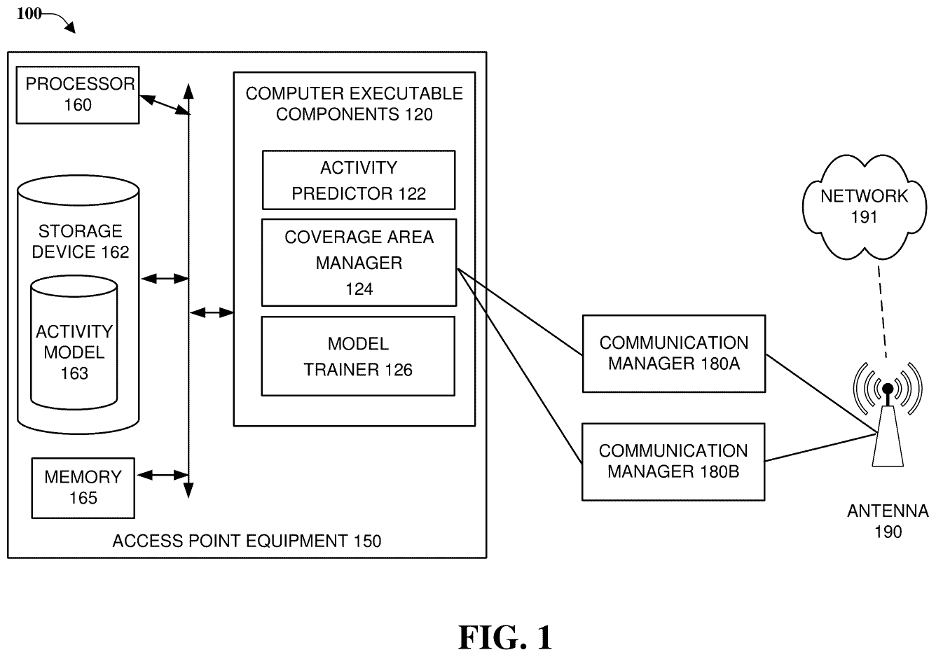

FIG. 1 is an architecture diagram of an example system 100 that can facilitate using radio resource management functions of an access point to model user activity and adjust operating parameters based thereon, in accordance with one or more embodiments. For purposes of brevity, description of like elements and/or processes employed in other embodiments is omitted. As depicted, system 100 includes access point equipment 150 connected to communication managers 180A-B. Communication managers 180A-B connect to antenna 190 which connects to network 191.

As depicted, access point equipment 150 can include memory 165 that can store one or more computer and/or machine readable, writable, and/or executable components 120 and/or instructions. In embodiments, access point equipment 150 can further include processor 160. In one or more embodiments, computer executable components 120, when executed by processor 160, can facilitate performance of operations defined by the executable component(s) and/or instruction(s). Computer executable components 120 can include activity predictor 122, coverage area manager 124, model trainer 126, and other components described or suggested by different embodiments described herein, that can improve the operation of system 100. Access point equipment 150 may further include storage device 162 that stores activity model 163. In an example, storage device 162 may provide nonvolatile storage of data, data structures, computer executable instructions, and so forth.

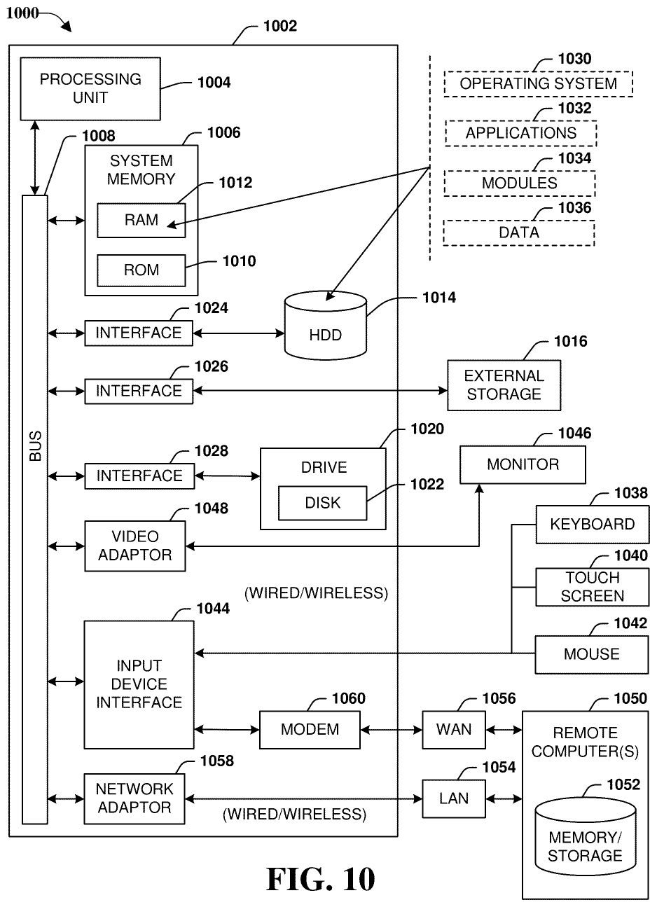

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1004 of FIG. 10. Such examples of processor 160 can be employed to implement any embodiments of the subject disclosure.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1006 and FIG. 10. Such examples of memory 165 can be employed to implement any embodiments of the subject disclosure.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of activity predictor 122, which can in some implementations can, by using an activity machine learning model applicable to demand for wireless communication in a coverage area served by an access point, predict a demand level for a future time period, resulting in a demand prediction, with the activity machine learning model being trained based on a time series of wireless activity data representative of wireless communication activity that has previously occurred within the coverage area, and with the access point including at least a first communication manager and a second communication manager.

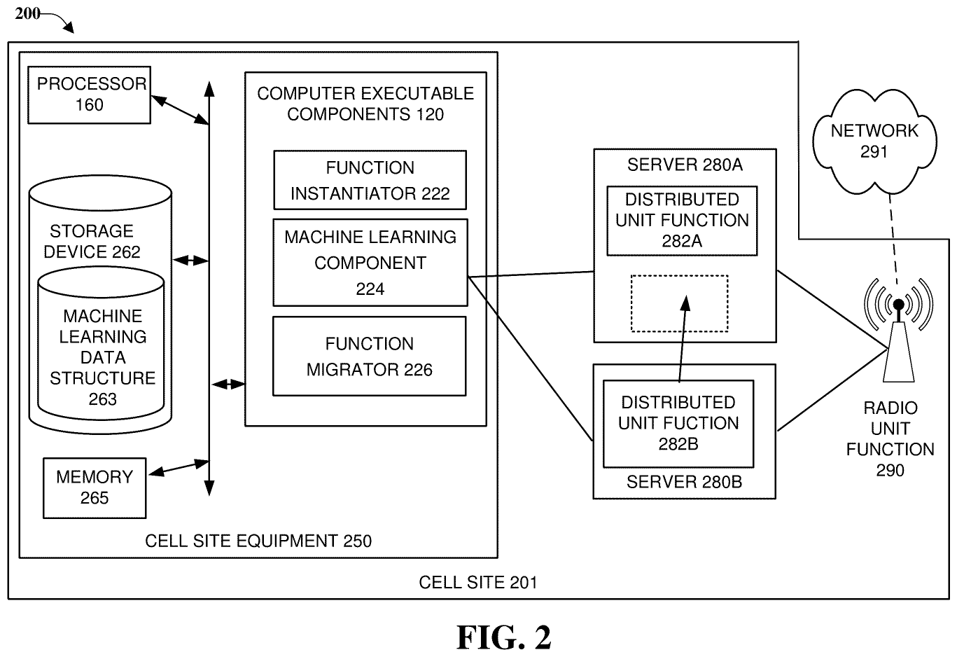

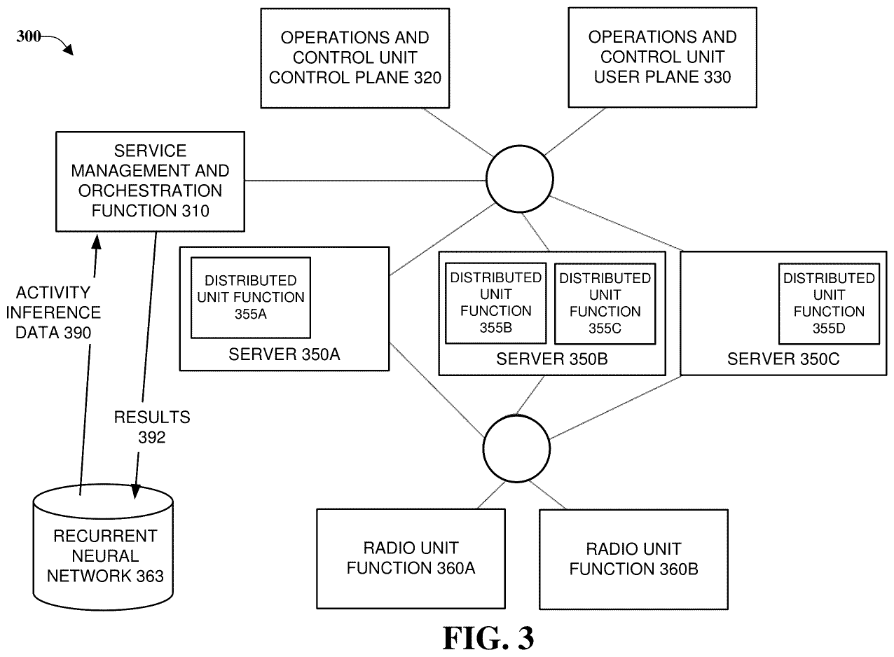

For example, in one or more embodiments, activity predictor 122 may, by using activity model 163, predict a demand level for a future time period, resulting in a demand prediction, with the activity machine learning model being trained based on a time series of wireless activity data representative of wireless communication activity of a coverage area served access point equipment 150, with access point equipment 150 including communication managers 180A-B. As discussed further with FIGS. 2-3 below, in one or more embodiments of communication managers 180A-B may be implemented as distributed units of an open radio access network (e.g., a DU of an O-RAN) applicable to manage communication between a centralized unit (e.g., a CU of the O-RAN) of the access point and a radio unit (e.g., an RU of the O-RAN) of the access point.

In another example, memory 165 can store executable instructions that can facilitate generation of coverage area manager 124, which in some implementations may, based on the demand prediction, adjust an operation parameter of the second communication manager to manage wireless communications within the coverage area during the future time period. For example, in one or more embodiments, coverage area manager 124 can, based on the demand prediction, adjust an operation parameter of communication manager 180A to manage wireless communications within the coverage area during the future time period. As discussed further with FIGS. 2-3 below, in one or more embodiments of coverage area manager 124 may be implemented by employing an instantiated service management and orchestration unit of the open radio access network (e.g., an SMO of the O-RAN).

In another example, memory 165 can store executable instructions that can facilitate generation of model trainer 126, which in some implementations may train the activity machine learning model using a time series of wireless activity data collected by the access point. For example, in one or more embodiments, model trainer 126 may train activity model 163 based on the time series of wireless activity data representative of wireless communication activity of a coverage area served access point equipment 150. As discussed further with FIGS. 2-3 below, in one or more embodiments of activity model 163 may be implemented as a recurrent neural network. An example recurrent neural network that may be utilized is a long short-term memory (LSTM) neural network. In some implementations, LSTM neural networks may be used based on a prediction accuracy rate from use being generally higher than with other types of machine learning approaches.

FIG. 2 is an architecture diagram of an example system 200 that can facilitate using radio resource management functions of an access point to model user activity and adjust operating parameters based thereon, in accordance with one or more embodiments. For purposes of brevity, description of like elements and/or processes employed in other embodiments is omitted. As depicted, system 200 includes cell site 201 with cell site equipment 250 connected to servers 280A-B. Server 280A-B respectively include distributed unit functions 282A-B coupled to radio unit function 290. Cell site equipment 250 includes processor 260, memory 265, storage device 262 that stores machine learning data structure 263, and computer executable components 220.

In embodiments, processor 260 is similar to processor 160 and storage device 262 is similar to storage device 162, discussed above. According to multiple embodiments, memory 265 can store one or more computer and/or machine readable, writable, and/or executable components 220 and/or instructions. In one or more embodiments, computer executable components 220, when executed by processor 260, can facilitate performance of operations defined by the executable component(s) and/or instruction(s). Computer executable components 220 can include function instantiator 222, machine learning component 224, function migrator 226, and other components described or suggested by different embodiments described herein, e.g., that can improve the operation of system 200, in accordance with one or more embodiments.

As discussed further with FIG. 10 below, network 291 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), fifth generation core (5G Core), fifth generation option 3x (5G Option 3x), high speed packet access (HSPA), Z-Wave, Zigbee and other 802.XX wireless technologies and/or legacy telecommunication technologies.

In an example implementation of cell site equipment 250, memory 265 can store executable instructions that can facilitate generation of function instantiator 222, which in some implementations, may instantiate a first distributed unit function of a network at a first server and a second distributed unit function of the network at a second server, with a subset of resource blocks of a grid of resource blocks being served by the first distributed unit function and the second distributed unit function. For example, one or more embodiments, function instantiator 222 may instantiate distributed unit function 282A hosted by server 280A, and distributed unit function 282B hosted by server 280B, with a subset of network 291 served by distributed unit functions 282A-B via radio unit function 290.

In an example implementation of cell site equipment 250, memory 265 can further store executable instructions that can facilitate generation of machine learning component 224, which in some implementations may, based on a sequence of activity values applicable to the subset of the resource blocks, modifying a weight of a recurrent connection represented in a machine learning data structure. For example, in one or more embodiments, machine learning component 224 may, based on a sequence of activity values applicable to the subset of network 291, modifying a weights of machine learning data structure 263.

In an implementation, machine learning component 224 may use key performance indicators (KPIs) of network 291 (e.g., a coverage area of cell site 201) collected by cell site 201 to train an RNN/LSTM model (e.g., machine learning data structure 263). In some implementations, the RNN/LSTM model may be trained wholly or in part by existing infrastructure of cell site 201, e.g., using an existing central processing unit (CPU) with no specialized hardware being required. In additional or alternative embodiments, a tensor processing unit and/or a graphics processing/compute unit may be implemented at cell site 201 to facilitate model training. As discussed further with FIGS. 2-3 below, in one or more embodiments of machine learning data structure 263 may be implemented as a recurrent neural network. An example recurrent neural network that may be utilized is a long short-term memory (LSTM) neural network.

In an example implementation of cell site equipment 250, memory 265 can further store executable instructions that can facilitate generation of function migrator 226, which in some implementations may, based on a power-conserving plan derived from inference data representative of an inference obtained from the machine learning data structure, migrating the first distributed unit function to the second server. For example, in one or more embodiments, function migrator 226 may, based on a power-conserving plan derived from activity inference data obtained from machine learning data structure 263, migrating distributed unit function 282B from server 280B to server 280A.

FIG. 3 includes a diagram that illustrates aspects of example system 300 that can facilitate using radio resource management functions of an access point to model user activity and adjust operating parameters based thereon, in accordance with one or more embodiments. For purposes of brevity, description of like elements and/or processes employed in other embodiments is omitted. System 300 includes operations and control unit control plane 320, operations and control unit user plane 330, service management and orchestration function 310, radio unit functions 360A-B, and servers 350A including distributed unit function 355A, server 350B including distributed unit functions 355B-C, and server 350C including distributed unit function 355D. Service management and orchestration function 310 is coupled to recurrent neural network 363 and may receive activity inference data 390 and further train recurrent neural network 363 based on results 392 of previous uses of activity inference data 390. Operations and control unit control plane 320, operations and control unit user plane 330, service management and orchestration function 310 are coupled to servers 350A-C which are coupled to radio unit functions 360A-B.

In one or more embodiments, distributed unit functions 355A-D are variously instantiated on servers 350A-C, e.g., by function instantiator 222. In embodiments, servers 350A-C are coupled to one or more servers (not shown), hosting radio unit functions 360A-B. In an example operation, to improve different performance characteristics of system 300, service management and orchestration function 310 may request in inference/prediction from recurrent neural network 363 regarding an upcoming period of time.

In an example, activity inference data 390 from recurrent neural network 363 may include an expected volume of wireless traffic within resource blocks of the handled coverage area, with this expected volume indicating that traffic will be less than a period where a current level of power allocated to distributed unit functions 355A-D is generally employed. Based on activity reference data 390, and characteristics of the operation of distributed unit functions 355A-D (e.g., power consumed for services provided) a power-conserving plan may be generated by embodiments.

In an implementation, one or more embodiments may predict long-term user activity per cell and output per-cell (e.g., predicted active users and/or predicted average spectrum utilization) by collating data from multiple cells per distributed unit functions 355A-D. Based on this predicted long term user activity, one or more embodiments nay identify candidate distributed unit functions for migration and/or other power conserving operating parameters.

In an implementation, an AI/ML application that hosts the RNN/LSTM model may share the RAN infrastructure. For example, in a distributed RAN and cell site with a collocated gNodeB centralized unit (gNB-CU), machine learning component 224 could run in a Kubernetes pod in the same cluster. Using this approach whereby machine learning functions are collocated with existing RAN infrastructure, for example, in a deployment with several gNB-CU aggregated at a datacenter, using existing AI infrastructure could speed up training of the activity model significantly by allowing parallel instantiation of the activity models of several cells.

An example power-conserving plan may change operating parameters for one or more of distributed user functions 355A-D and servers 350A-C. An example parameter that may be used to implement the power-conserving plan is a deactivation/suspension of distributed unit function 355A, e.g., reducing the computing load of server 350A. In addition, the parameters generated by embodiments may specify that all or part of server 350A may be powered down. As a part of the suspension of the use of distributed unit function 355A, user active sessions handled by distributed unit function 355A may be identified, and migrated to distributed unit function 355B for handling thereby. In accordance with the power-conserving plan, different operating parameters of server 350B may be altered to facilitate this migration.

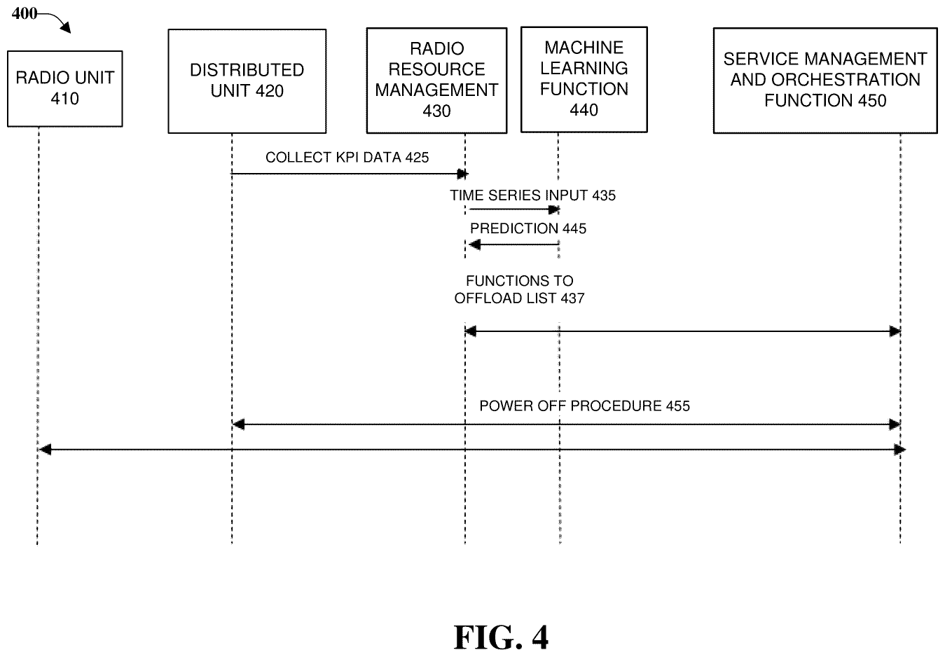

FIG. 4 includes a sequence diagram that illustrates aspects of example system 400 that can facilitate using radio resource management functions of an access point to model user activity and adjust operating parameters based thereon, in accordance with one or more embodiments. For purposes of brevity, description of like elements and/or processes employed in other embodiments is omitted. System 400 depicts exchange of data among radio unit 410, distributed unit 420, radio resource management 430, machine learning function 440, and service management and orchestration function 450.

In an embodiment, at 425, KPI data is collected for the cell site coverage area and forwarded to radio resource management 430. At 435, the KPI data may be in a time series for input to machine learning function 440 (e.g., model trainer 126, machine learning component 224). In an example, an LSTM model may be trained based on cell-specific time series data that is generally used by radio resource management 430. In an example, the KPIs may represent the traffic pattern in the cell and be collected both from the centralized unit and distributed unit protocol layers. Example KPIs that may be useful to embodiments include, but are not limited to, an average number of radio resource control connections (RRC.ConnMean), a number of session management packet data unit session setup requests (SM.PDUSessionSetupReq), and a utilization of radio remote unit physical resource block downlink/uplink resources (RRU.PrbUsedDl/RRU.PrbUsedUl). In one or more embodiments, the KPIs may be used individually or combinations of KPIs may be aggregated to form a representative metric. Using locally collected KPIs to perform training of the machine learning model locally, may improve network scalability, because training time may be reduced, and function may be integrated into existing centralized unit functions.

In embodiments, machine learning function 440 may train a machine learning model (e.g., activity model 163, machine learning data structure 263). Notwithstanding radio resource management 430 and machine learning function 440 being depicted in system 400 as separate, one or more embodiments may implement machine learning function in an existing radio resource management instance, e.g., deployed in operations and control unit control plane 320/user plane 330 of the access point (e.g., gNodeB), or in service management and orchestration function 310/RAN intelligent controller (not shown) instances.

At 445, radio resource management 430 may request a prediction (e.g., activity inference data 390, a demand level for a future time period, a predicted number of active users for the future time period, a traffic prediction). At 437, based on analysis and information from service management and orchestration function 450, a plan to offload different network functions may be generated based on the prediction. In one or more embodiments, offloading/reallocating different network functions may facilitate regulation, by a centralized unit function, of traffic for existing UEs and admission control for incoming UEs, e.g., to prepare for a potential shut down of the cell. One or more embodiments may use the advance notice of traffic changes to reduce the service impact of various energy saving actions. For example, notifications may be provided to service management and orchestration functions 450 and/or operations and maintenance functions (not shown) that include a list of candidate cells and a duration of predicted low activity. At 455, a power off procedure may be performed to implement the function offloading plan, e.g., migrating users from selected distributed unit functions, suspending/migrating distributed unit functions, and powering down servers.

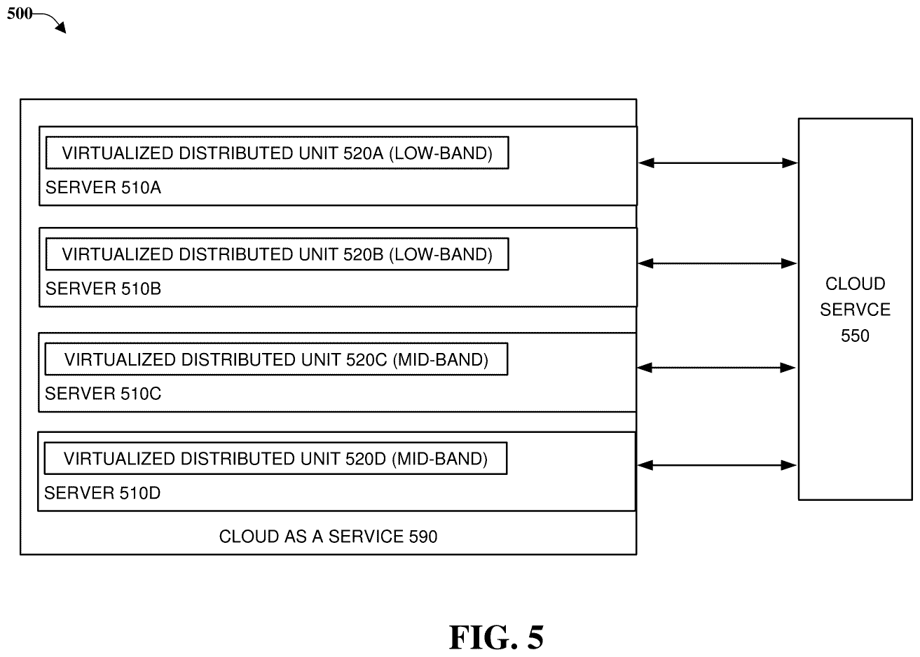

FIG. 5 includes a diagram that illustrates aspects of example system 500 that can facilitate using radio resource management functions of an access point to model user activity and adjust operating parameters based thereon, in accordance with one or more embodiments. For purposes of brevity, description of like elements and/or processes employed in other embodiments is omitted. System 500 includes servers 510A-D implementing cloud as a service 590. Servers 510A-B respectively include virtualized distributed units 520A-B and servers 510C-D respectively include virtualized distributed units 520C-D. Cloud as a service 590 provides cloud service 550.

In an example, virtualized distributed units 520A-B are instantiated to handle low-band communications for cloud service 550, and virtualized distributed units 520C-D are instantiated to handle mid-band communications for cloud service 550. In accordance with one or more embodiments, based on a sequence of activity values applicable to a coverage area of cloud as a service 590, a machine learning model may be trained to model future user activity. To reduce the power consumed by cloud as a service 590 equipment, based on the model of future user activity, a power-conserving plan may be generated that suspends operation of one or more virtualized distributed units 520A-D and corresponding operations of servers 510A-D.

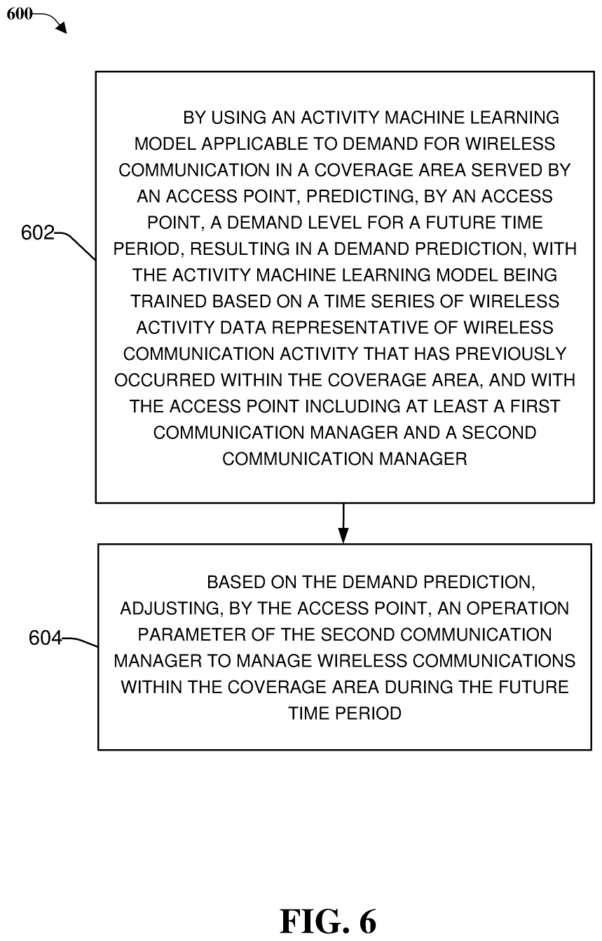

FIG. 6 depicts a flow diagram representing example operations of an example method 600 that can facilitate using radio resource management functions of an access point to model user activity and adjust operating parameters based thereon, in accordance with one or more embodiments. For purposes of brevity, description of like elements and/or processes employed in other embodiments is omitted.

In some examples, one or more embodiments of method 600 can be implemented by activity predictor 122, coverage area manager 124, model trainer 126, and other components that can be used to implement aspects of method 600, in accordance with one or more embodiments. FIG. 6, described below illustrates methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

At 602 of method 600, activity predictor 122 of access point equipment 150 can, by using an activity machine learning model applicable to demand for wireless communication in a coverage area served by an access point, predict a demand level for a future time period, resulting in a demand prediction, with the activity machine learning model being trained based on a time series of wireless activity data representative of wireless communication activity that has previously occurred within the coverage area, and with the access point including at least a first communication manager and a second communication manager. At 604 of method 600, coverage area manager 124 can adjust an operation parameter of the second communication manager to manage wireless communications within the coverage area during the future time period. At 606 of method 600, model trainer 126 can train the activity machine learning model using a time series of wireless activity data collected by the access point.

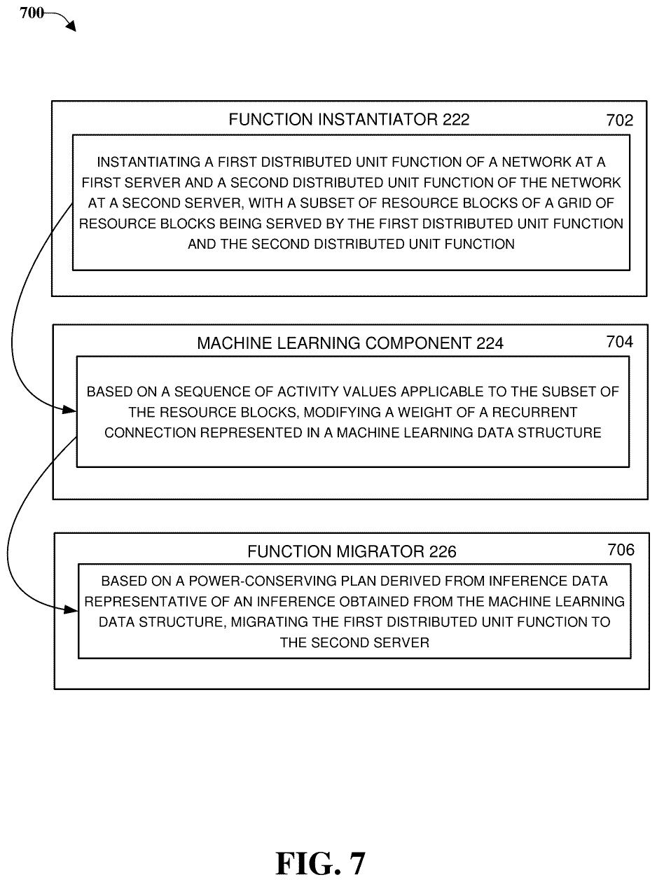

FIG. 7 depicts an example system 700 that can facilitate using radio resource management functions of an access point to model user activity and adjust operating parameters based thereon, in accordance with one or more embodiments. For purposes of brevity, description of like elements and/or processes employed in other embodiments is omitted.

System 700 includes at least one memory that stores computer executable components, and at least one processor that executes the computer executable components stored in the at least one memory, with the computer executable components including function instantiator 222, machine learning component 224, function migrator 226, and other components that can be used to implement aspects of system 700, as described herein, in accordance with one or more embodiments.

At 702 of FIG. 7, function instantiator 222 can instantiate a first distributed unit function of a network at a first server and a second distributed unit function of the network at a second server, with a subset of resource blocks of a grid of resource blocks being served by the first distributed unit function and the second distributed unit function. At 704 of FIG. 7, machine learning component 224 can based on a sequence of activity values applicable to the subset of the resource blocks, modify a weight of a recurrent connection represented in a machine learning data structure. At 706 of FIG. 7, function migrator 226 may, based on a power-conserving plan derived from inference data representative of an inference obtained from the machine learning data structure, migrate the first distributed unit function to the second server.

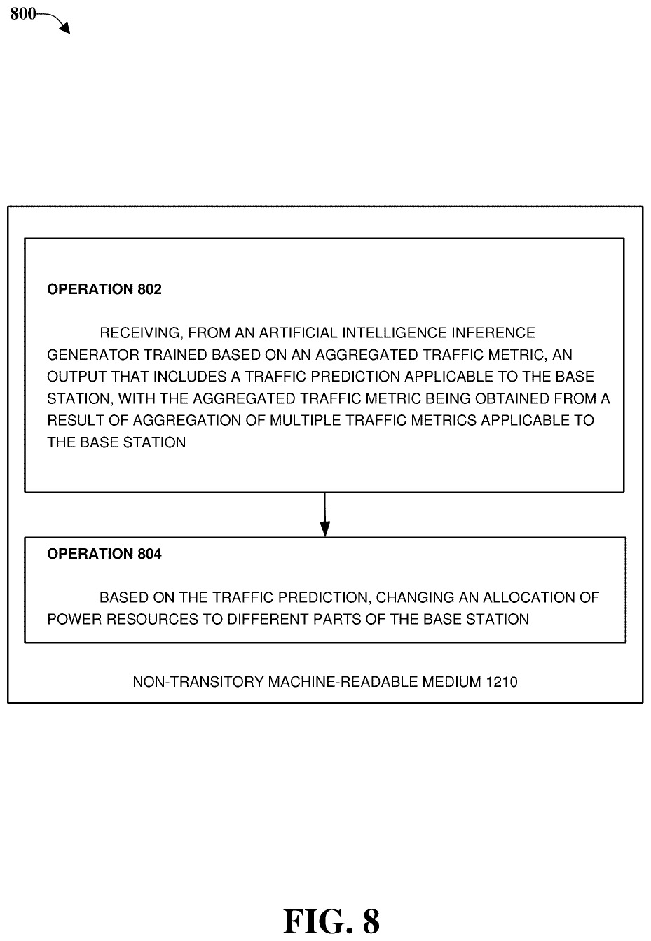

FIG. 8 depicts an example 800 non-transitory machine-readable medium 810 that can include executable instructions that, when executed by a processor of a system, can facilitate using radio resource management functions of an access point to model user activity and adjust operating parameters based thereon, in accordance with one or more embodiments. For purposes of brevity, description of like elements and/or processes employed in other embodiments is omitted.

As depicted, non-transitory machine-readable medium 810 includes executable instructions that, when executed by at least one processor of a machine learning device, facilitate performance of operations that include operation 802 which can receive, from an artificial intelligence inference generator trained based on an aggregated traffic metric, an output that includes a traffic prediction applicable to the base station, with the aggregated traffic metric being obtained from a result of aggregation of multiple traffic metrics applicable to the base station. The operations may further include operation 804 which can, based on the traffic prediction, change an allocation of power resources to different parts of the base station.

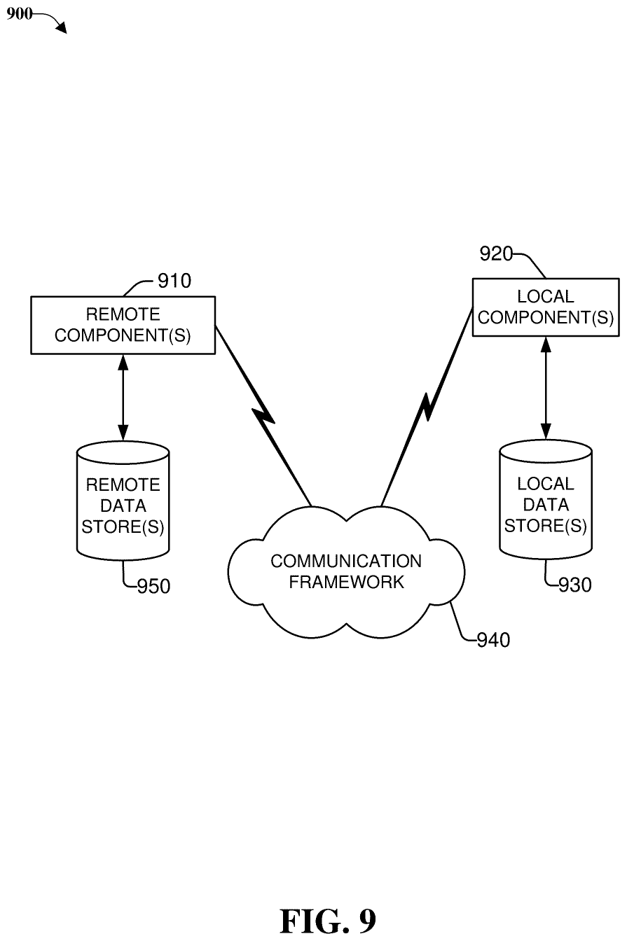

FIG. 9 is a schematic block diagram of a system 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, RAN devices, gateway devices, femtocell devices, servers, etc. The system 900 also comprises one or more local component(s) 920. The local component(s) 920 can be hardware and/or software (e.g., threads, processes, computing devices).

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1020 (see below), non-volatile memory 1022 (see below), disk storage 1024 (see below), and memory storage, e.g., local data store(s) 930 and remote data store(s) 950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in different systems, e.g., both local and remote memory storage devices.

Referring now to FIG. 10, in order to provide additional context for various embodiments described herein, FIG. 10 and the following discussion are intended to provide a brief, general description of a suitable computing environment 1000 in which the various embodiments described herein can be implemented.

While the embodiments have been described above in the general context of computer executable instructions that can run on one or more computers, those skilled in the art will recognize that the embodiments can be also implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the . NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can also be connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application program interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network,” “core,” “core carrier network,” “carrier-side,” or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) RAN or GERAN; UMTS Terrestrial Radio Access Network (UTRAN); or LTE Advanced.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such features may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
using an activity machine learning model applicable to demand for wireless communication in a coverage area served by an access point, predicting, by the access point comprising one or more processors, a demand level for a future time period, resulting in a demand prediction, wherein the activity machine learning model was trained based on a time series of wireless activity data representative of wireless communication activity that has previously occurred within the coverage area, and wherein the access point comprises at least a first communication manager and a second communication manager; and
based on the demand prediction, adjusting, by the access point, an operation parameter of the second communication manager to manage wireless communications within the coverage area during the future time period.

2. The method of claim 1, further comprising collecting, by the access point, the time series of wireless activity data for use in training the activity machine learning model.

3. The method of claim 1, wherein the time series comprises key performance indicators comprising at least one of:
a first indicator of an average number of radio resource control connections, a second indicator of a number of session management packet data unit session setup requests, or third indicator of a utilization of radio remote unit physical resource block downlink/uplink resources.

4. The method of claim 1, wherein the first communication manager comprises a distributed unit applicable to manage communication between a centralized unit of the access point and a radio unit of the access point.

5. The method of claim 1, wherein the access point comprises a next-generation node B access point.

6. The method of claim 1, wherein the demand prediction comprises a predicted number of active users for the future time period.

7. The method of claim 1, wherein the altering of the operation parameter comprises suspending operation of the second communication manager.

8. The method of claim 7, further comprising, before the suspending of the operation of the second communication manager, migrating active user sessions maintained by the second communication manager to the first communication manager.

9. The method of claim 1, wherein the adjusting of the operation parameter is further based on a combination of energy savings and demand fulfillment.

10. The method of claim 1, wherein the activity machine learning model comprises a recurrent neural network.

11. The method of claim 10, wherein the recurrent neural network comprises a long short-term memory neural network.

12. The method of claim 1, wherein the adjusting of the operation parameter of the second communication manager comprises notifying a service management and orchestration function of an applicability of the demand prediction to the second communication manager.

13. Network equipment, comprising:
at least one memory that stores machine executable instructions; and
at least one processor configured to process the machine executable instructions that, when executed by the at least one processor, facilitate performance of operations, comprising:
instantiating a first distributed unit function of a network at a first server and a second distributed unit function of the network at a second server, wherein a subset of resource blocks of a grid of resource blocks is served by the first distributed unit function and the second distributed unit function,
based on a sequence of activity values applicable to the subset of the resource blocks, modifying a weight of a recurrent connection represented in a machine learning data structure, and
based on a power-conserving plan derived from inference data representative of an inference obtained from the machine learning data structure, migrating the first distributed unit function to the second server.

14. The network equipment of claim 13, wherein the inference is applicable to an expected volume of wireless traffic within the subset of the resource blocks.

15. The network equipment of claim 13, wherein the power-conserving plan comprises a plan to reduce power consumption by the network equipment by suspending use of the first server for distributed unit functions.

16. The network equipment of claim 13, wherein the operations further comprise:
instantiating an operations, administration, and maintenance function applicable to the migrating of the first distributed unit function to the second server.

17. The network equipment of claim 13, wherein the operations further comprise:
based on the power-conserving plan, deactivating the second distributed unit function.

18. The network equipment of claim 13, wherein the operations further comprise:
based on training data received from a control plane of a centralized unit, further modifying the weight of the recurrent connection represented in the machine learning data structure.

19. A non-transitory machine-readable medium comprising executable instructions that, when executed by at least one processor of a base station that is part of a wireless network, facilitate performance of operations, the operations comprising:
receiving, from an artificial intelligence inference generator trained based on an aggregated traffic metric, an output comprising a traffic prediction applicable to the base station, wherein the aggregated traffic metric was obtained from a result of aggregation of multiple traffic metrics; and
based on the traffic prediction, changing an allocation of power resources to different parts of the base station.

20. The non-transitory machine-readable medium of claim 19, wherein the multiple traffic metrics are limited to traffic metrics applicable to the base station.
